(19) United States
(12) Patent Application Publication
(10) Pub. No.: US 2025/0254612 A1
(43) Pub. Date: Aug. 7, 2025

(54) ELECTRONIC APPARATUS, ELECTRONIC APPARATUS CONTROL METHOD, AND STORAGE MEDIUM STORING ONE OR MORE PROGRAMS THEREIN

(71) Applicant: CANON KABUSHIKI KAISHA, Tokyo (JP)

(72) Inventor: KOHEI YAMADA, Kanagawa (JP)

(21) Appl. No.: 19/043,016

(22) Filed: Jan. 31, 2025

(30) Foreign Application Priority Data
Feb. 7, 2024 (JP) 2024-017433

(51) Int. Cl. H04W 48/20; H04W 48/16; H04W 52/02; H04W 76/20

(52) U.S. Cl. CPC H04W 48/20; H04W 48/16; H04W 52/0287; H04W 76/20

(57) ABSTRACT

An electronic apparatus includes receiving, from a currently connected access point, a change request to change an access point that is a connection destination, performing control so that processing for changing the connection destination based on the change request is not performed if the electronic apparatus is in, from among a first mode and a second mode, the first mode, where a clock frequency of the at least one processor is lower in the second mode than in the first mode, and performing control so that the processing for changing the connection destination based on the change request is performed if the electronic apparatus is in the second mode

### BACKGROUND

### Field

The present disclosure relates to a wireless LAN-compatible electronic apparatus, an electronic apparatus control method, and a storage medium storing one or more programs.

### Description of the Related Art

There is a technique in which, in an extended service set (ESS) formed from a plurality of access points (APs), the connection-destination AP is dynamically switched for efficient data exchange between the APs and a station (STA). The AP to which the STA is currently connected transmits a connected AP change request to the STA if it is determined, based on the degree of congestion of the currently connected AP, the availability of other APs, radio wave conditions, etc., that the connection-destination AP should be switched. Upon receiving the AP change request, the STA can establish connection with an appropriate AP by switching the connection-destination AP in accordance with the request.

Japanese Patent Laid-Open No. 2021-175068 discloses processing in which a router having an AP function requests a wireless client currently connected thereto to change the connection destination. A mobile router (MR 1) that can establish connection with a plurality of wireless clients checks whether a wireless client terminal is compatible with IEEE 802.11v. The determination of whether the wireless client terminal is compatible with IEEE 802.11v can be made based on an Association Request frame that the wireless client terminal transmits upon establishing wireless connection with MR 1. If the wireless client terminal is compatible with IEEE 802.11v, MR 1 transmits a BSS Transition Management (BTM) Request frame to the corresponding wireless client terminal. A BSS Transition Candidate List Entries field in the BTM Request frame designates a BSSID of a master router RT 2 as the connection destination. Thus, switching of the connection destination of the wireless client terminal is prompted, and the wireless client terminal switches the connection destination from MR 1 to RT 2 based on the received BTM Request frame.

### SUMMARY

The present disclosure provides an electronic apparatus, an electronic apparatus control method, and a storage medium storing one or more programs that more appropriately change the connection destination access point.

According to an aspect of the present disclosure an electronic apparatus comprises a communication device configured to receive, from a currently connected access point, a change request to change an access point that is a connection destination, and at least one memory storing a program and at least one processor that when executing the program is configured to perform control so that processing for changing the connection destination based on the change request is not performed if the electronic apparatus is in, from among a first mode and a second mode, the first mode, where a clock frequency of the at least one processor is lower in the second mode than in the first mode, and perform control so that processing for changing the connection destination based on the change request is performed if the electronic apparatus is in the second mode.

According to the present disclosure, the connection destination access point can be more appropriately changed.

Further features of the present disclosure will become apparent from the following description of exemplary embodiments with reference to the attached drawings.

### BRIEF DESCRIPTION OF THE DRAWINGS

FIG. 1 is a diagram illustrating a system configuration.

FIGS. 2A and 2B are diagrams illustrating a configuration of a multi-function peripheral.

FIGS. 3A to 3C are diagrams illustrating an operation display unit of the multi-function peripheral.

FIGS. 4A and 4B are diagrams illustrating a configuration of a portable terminal apparatus.

FIG. 5 is a diagram illustrating a configuration of an access point.

FIG. 6 is a sequence diagram for describing processing executed based on a connection destination change request from an access point.

FIG. 7 is a flowchart illustrating processing executed based on a connection destination access point change request.

FIG. 8 is a flowchart illustrating processing executed based on a connection destination access point change request.

### DESCRIPTION OF THE EMBODIMENTS

Hereinafter, embodiments will be described in detail with reference to the attached drawings. The following embodiments are not intended to limit the scope of the present disclosure. Multiple features are described in the embodiments, these features are not seen to be limiting, not all features are required, and multiple features may be combined as appropriate. In the attached drawings, the same reference numerals are provided to the same or similar configurations, and redundant description thereof is omitted.

### First Exemplary Embodiment

### System Configuration

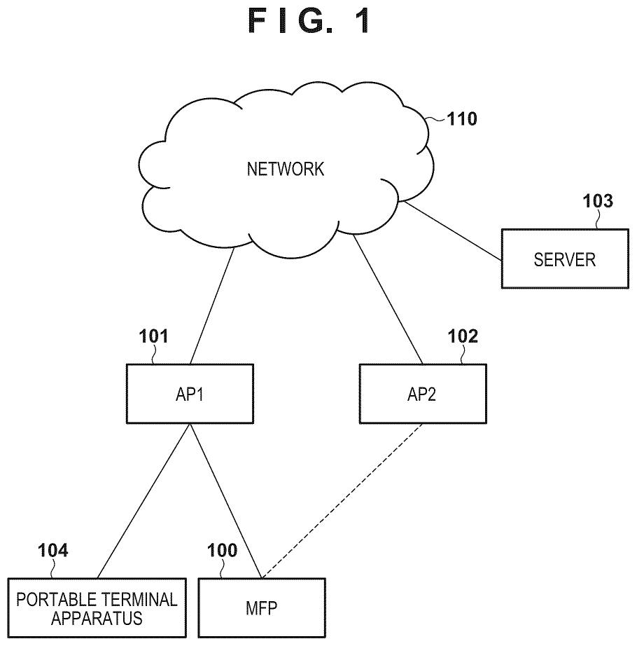

FIG. 1 illustrates an example configuration of a system according to a first exemplary embodiment. In an example, the present system is a wireless communication system in which a plurality of communication apparatuses can communicate wirelessly with one another. The example in FIG. 1 includes a portable terminal apparatus 104 and a multi-function peripheral (MFP) 100 as communication apparatuses; an access point (AP) 101 and an AP 102, a server 103, and a network 110. The AP 101 and the AP 102 may be illustrated as AP1 and AP2. The portable terminal apparatus 104 is an apparatus that has a wireless communication function based on wireless LAN, etc. Hereinafter, wireless LAN may be referred to as WLAN. The portable terminal apparatus 104 may be a personal information terminal such as a personal digital assistant (PDA), a mobile phone (smartphone), a digital camera, a personal computer, or the like.

The MFP 100 is a printing apparatus having a printing function, and may also have a reading function (scanner), a FAX function, and a telephone function. The MFP 100 according to the present embodiment has a communication function that can wirelessly communicate with the portable terminal apparatus 104. While a case in which the MFP 100 is used is described as an example in the present embodiment, this is not seen to be limiting. For example, a scanner apparatus, a projector, a portable terminal, a smartphone, a laptop PC, a tablet terminal, a PDA, a digital camera, a music playback device, a television set, a smart speaker, or the like each having a communication function may be used in place of the MFP 100.

The AP 101 is provided separately (externally) from the portable terminal apparatus 104 and the MFP 100, and operates as a WLAN base station apparatus. Communication apparatuses having a WLAN communication function can communicate in the WLAN infrastructure mode via the AP 101 . . . . The infrastructure mode may be referred to as “wireless infrastructure mode”. The AP 101 wirelessly communicates with a communication apparatus permitted (authenticated) to connect to the AP 101, and relays wireless communication between the communication apparatus and another communication apparatus. The AP 101 may be connected to a wired communication network, for example, and may relay communication between a communication apparatus that is connected to the wired communication network and another communication apparatus that is wirelessly connected to the AP 101.

The AP 102 has functions equivalent to those of the AP 101. The MFP 100 switches connection from the AP 101 to the AP 102 as necessary. The server 103 connects to the MFP 100 via the AP 101 and the network 110, and provides services to the MFP 100 by responding to requests from the MFP 100. The network 110 may be the so-called Internet, or may be a corporate intranet or a mobile phone network. The system according to the present embodiment is not limited the configuration illustrated in FIG. 1, and, for example, may include an authentication server that performs the above-described authentication, etc.

### External Configuration of MFP

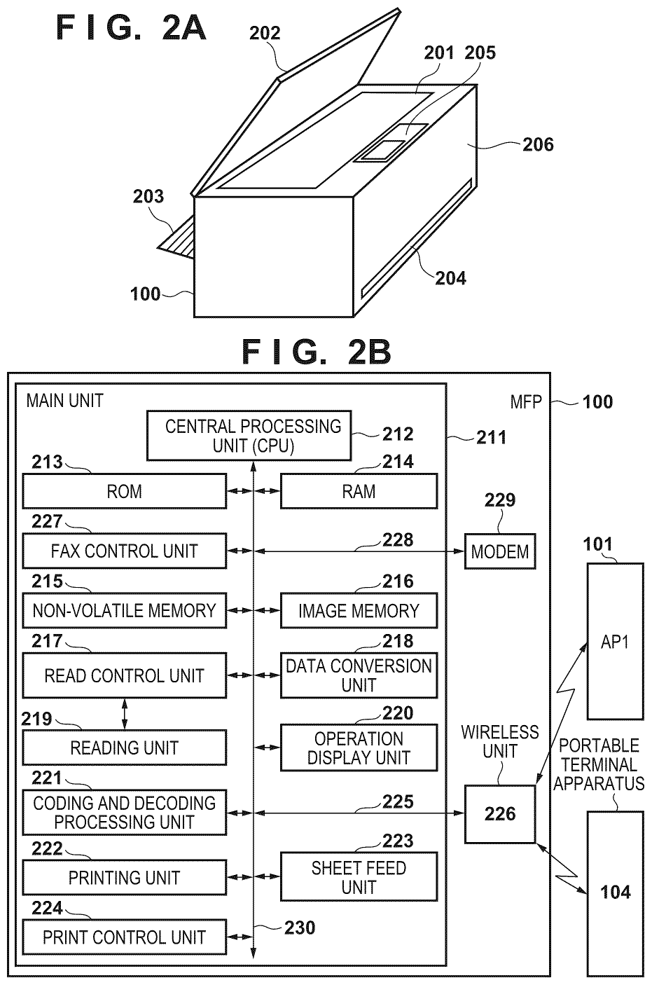

FIG. 2A illustrates an example of an external configuration of the MFP 100. The MFP 100 includes, for example, a document table 201, a document cover 202, a printing paper insertion port 203, a printing paper discharge port 204, and an operation display unit 205. The document table 201 is a table on which a document to be read is placed. The document cover 202 is a cover for holding down the document placed on the document table 201 and preventing light from a light source with which the document is irradiated during reading from leaking external to the MFP 100. The printing paper insertion port 203 is an insertion port to which sheets of various sizes are provided. The printing paper discharge port 204 is a discharge port from which printed sheets are discharged. Sheets provided to the printing paper insertion port 203 are conveyed one sheet at a time to a printing unit, and are then discharged from the printing paper discharge port 204 after printing is performed thereon in the printing unit. The operation display unit 205 includes LEDs, an LCD, keys such as character input keys, cursor keys, an OK key, and a cancel key, etc., and can accept user operations for activating various MFP functions and configuring various settings. The operation display unit 205 may include a touch panel display. The MFP 100 has the WLAN wireless communication function, and includes a wireless communication antenna 206 for the wireless communication, where the wireless communication antenna 206 may not necessarily be visible external to the MFP 100. As with the portable terminal apparatus 104, the MFP 100 can also perform wireless communication in the 2.4 GHz and 5 GHz frequency bands by means of WLAN.

### Configuration of MFP

FIG. 2B illustrates an example configuration of the MFP 100. The MFP 100 includes a main board 211 that performs control of the MFP 100, and a wireless unit 226 that is a single communication module (communication interface) that performs WLAN communication using at least one common antenna. The MFP 100 includes, for example, a modem 229 for performing wired communication. The main board 211 includes, for example, a central computation processing unit (CPU) 212, a read only memory (ROM) 213, a random access memory (RAM) 214, a non-volatile memory 215, an image memory 216, a read control unit 217, a data conversion unit 218, a reading unit 219, and a coding and decoding processing unit 221. The main board 211 also includes, for example, a printing unit 222, a sheet feed unit 223, a print control unit 224, and an operation display unit 220. These functional units in the main board 211 are connected to one another via a system bus 230 that is managed by the CPU 212. The main board 211 and the wireless unit 226 are connected, for example, via a dedicated bus 225, and the main board 211 and the modem 229 are connected, for example, via a bus 228.

The CPU 212 is a system control unit that includes at least one processor, and controls the MFP 100. In an example, the below described processing by the MFP 100 is realized by the CPU 212 executing programs stored in the ROM 213. Elements of dedicated hardware for individual types of processing may be provided. The ROM 213 stores control programs, a built-in OS program, etc., that are to be executed by the CPU 212. In the present embodiment, the CPU 212 performs software control such as scheduling and task switching by executing the control programs stored in the ROM 213 under management by the built-in OS, which is similarly stored in the ROM 213.

The RAM 214 is formed from an SRAM or the like. The RAM 214 stores therein data such as program control variables, and data such as setting values registered by the user and management data of the MFP 100. The RAM 214 can be used as a buffer for various types of work. For example, the non-volatile memory 215 is formed from a memory such as a flash memory, and retains data stored therein even if the MFP 100 is turned off. The image memory 216 is formed from a memory such as a DRAM. The image memory 216 accumulates image data received via the wireless unit 226, image data processed by the coding and decoding processing unit 221, etc. The memory configuration of the MFP 100 is not limited to the above-described configuration. The data conversion unit 218 performs analysis of data of various formats, conversion from image data to print data, etc.

The read control unit 217 optically reads a document placed on the document table 201 by controlling the reading unit 219 (for example, a contact image sensor (CIS)). The read control unit 217 converts the image obtained by optically reading the document into electrical image data (image signal), and outputs the image data. The read control unit 217 may output the image data after applying various types of image processing such as binarization processing and halftone processing to the image data.

The operation display unit 220 is the operation display unit 205 described with reference to FIG. 2A, and executes display on a display based on display control by the CPU 212, signal generation based on user operations that are accepted, etc. The coding and decoding processing unit 221 performs enlargement/reduction processing and coding/decoding processing on image data (JPEG, PNG, etc.) handled in the MFP 100.

The sheet feed unit 223 holds printing sheets. Under control by the print control unit 224, the sheet feed unit 223 can supply sheets that are provided thereto. The sheet feed unit 223 may include a plurality of sheet feed units so that a plurality of types of sheets can be held in one apparatus. In the present embodiment, the sheet feed unit 223, under control by the print control unit 224, can perform control to determine the sheet feed unit from which sheets are to be fed.

The print control unit 224 applies various types of image processing, such as smoothing processing, print density correction processing, and color correction, to image data to be printed, and outputs the processed image data to the printing unit 222. For example, the printing unit 222 is configured to execute print processing of the inkjet printing method, and prints an image on a printing medium such as a sheet by causing a print head to eject ink supplied from an ink tank. The printing unit 222 may be configured to execute print processing of other types, such as that of the electrophotographic method. The print control unit 224 can read information about the printing unit 222 on a regular basis to update status information that is stored in the RAM 214, including the remaining ink level in the ink tank, print head state, etc.

The wireless unit 226 is a unit that can provide the WLAN communication function, and can provide a function similar to that of a WLAN unit 429 of the portable terminal apparatus 104. Specifically, in accordance with a WLAN standard, the wireless unit 226 converts data into packets and transmits the packets to other devices, and reconstructs original data from packets from external devices and outputs the original data to the CPU 212. The wireless unit 226 can perform communication as a station (STA) that is compliant with the IEEE 802.11 series of standards. In particular, the wireless unit 226 can perform communication as a station that is compliant with IEEE 802.11a/b/g/n/ac/ax. The wireless unit 226 can perform communication as an STA that is compatible with Wi-Fi Agile Multiband™.

The wireless unit 226 is compatible with IEEE 802.11ax, i.e., Wi-Fi 6™. The MFP 100 can operate as an STA that is compatible with at least orthogonal frequency division multiple access (OFDMA) or Target Wake Time (TWT). Since the wireless unit 226 is compatible with TWT, the timings of data communication from the AP to the STA are adjusted. The wireless unit 226 (MFP 100), which is the STA, switches the communication function thereof to a sleep state whenever there is no need to wait for signal reception. Power consumption can thus be suppressed. The wireless unit 226 is also compatible with Wi-Fi 6E™. That is, the wireless unit 226 can also perform communication in the 6 GHz band (5.925-7.125 GHz). Frequency bands in the 5 GHz band in which Dynamic Frequency Selection (DFS) is performed are not present in the 6 GHz band. Thus, disconnection of communication due to DFS wait time does not occur in communication in the 6 GHz band, and communication with a higher level of comfort can be expected.

The portable terminal apparatus 104 and the MFP 100 can perform WFD-based P2P (WLAN) communication. The wireless unit 226 has a software access point (software AP) function or a group owner function. That is, the wireless unit 226 can construct a peer-to-peer (P2P) communication network and determine the channel to be used for P2P communication.

### Operation Display Unit of MFP

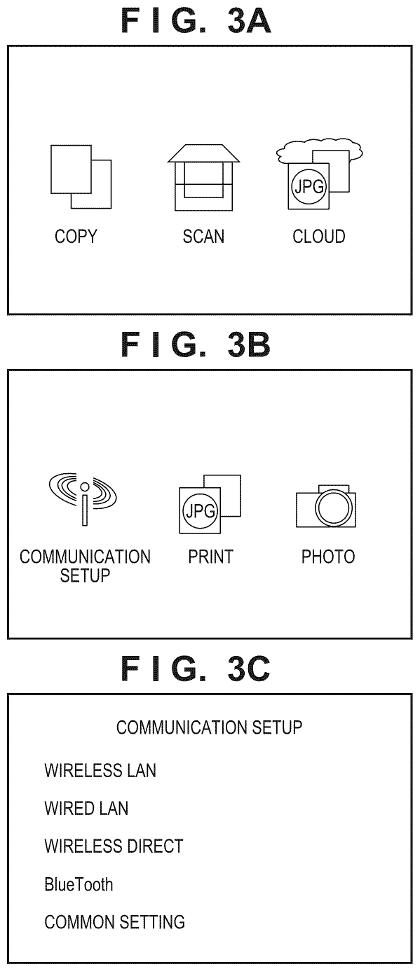

FIGS. 3A to 3C illustrate examples of screens displayed on the display (touch panel display) included in the operation display unit 220 of the MFP 100. FIG. 3A illustrates an example of a home screen that is displayed during a state (idle state, standby state) in which the MFP 100 is turned on and no operation such as printing and scanning is being performed. In FIG. 3A, display items (menu items) corresponding to “Copy”, “Scan”, and “Cloud” are displayed. “Cloud” is a menu item relating to a cloud function in which Internet communication is used. When one of the menu items is selected as a result of a key operation or a touch panel operation, the MFP 100 can start executing the corresponding setup or function. By accepting a key operation or a touch panel operation on the home screen in FIG. 3A, the MFP 100 can seamlessly display a screen that is different from that in FIG. 3A.

FIG. 3B illustrates an example display of another portion of the home screen, and illustrates a screen to which the home screen transitions from the state in FIG. 3A as a result of an operation (a left-right slide operation or the like) for displaying a different home screen page. In FIG. 3B, display items (menu items) corresponding to “Communication Setup”, “Print”, and “Photo” are displayed. When one of these menu items is selected, a function corresponding to the selected menu item, i.e., the print function, the photo function, or communication setup, is executed.

FIG. 3C illustrates an example display of a communication setup menu screen that is displayed if “Communication Setup” is selected on the screen in FIG. 3B. On the communication setup menu screen, “Wireless LAN”, “Wired LAN”, “Wireless Direct”, and “Bluetooth” are displayed as menu items (options). “Wireless LAN”, “Wired LAN”, and “Wireless Direct” are menu items for configuring LAN settings, and wired connection settings, settings for enabling/disabling the wireless infrastructure mode, settings for enabling/disabling a P2P mode such as the WFD or software AP mode, etc., can be configured from these items. If the item “Wireless LAN” is selected and wireless LAN is enabled by a user operation, the wireless infrastructure mode is enabled. If the item “Wireless Direct” is selected and wireless direct is enabled by a user operation, the P2P (WLAN) mode is enabled. A common settings menu relating to all connection modes is also displayed on this screen. The user can also set the wireless LAN frequency band and frequency channel, etc., from this screen.

### External Configuration of Portable Terminal Apparatus

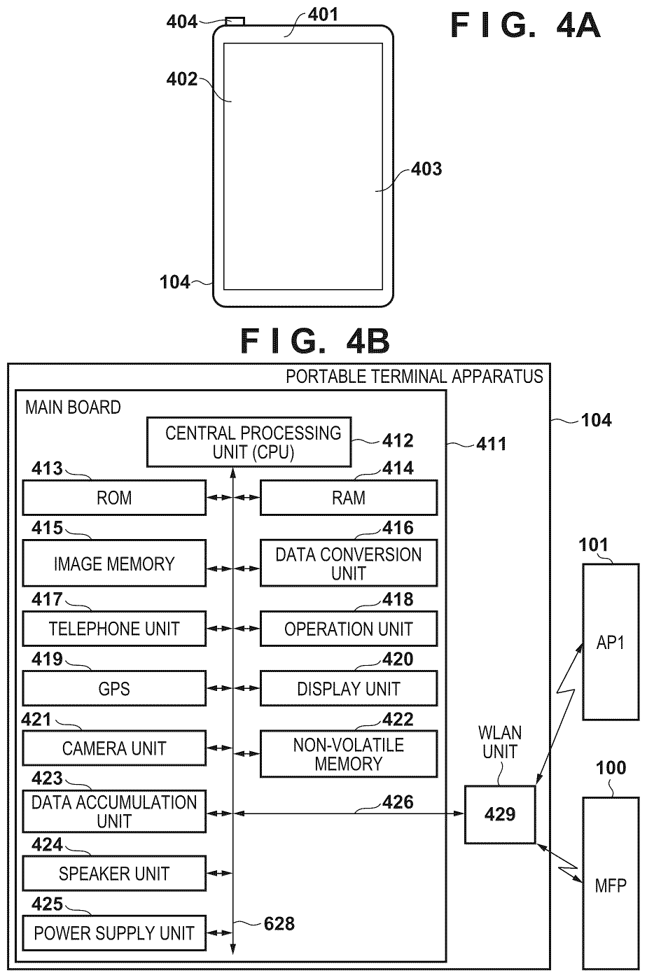

FIG. 4A is a diagram illustrating an example of an external configuration of the portable terminal apparatus 104. An example of the portable terminal apparatus 104 for the present embodiment is a smartphone. The portable terminal apparatus 104 includes, for example, a display unit 402, an operation unit 403, and a power key 404. The display unit 402 is a display including, for example, a liquid crystal display (LCD)-type display mechanism. The display unit 402 may, for example, display information using light-emitting diodes (LEDs), etc. The portable terminal apparatus 104 may have a function of outputting information via voice in addition to or in place of the display unit 402. The operation unit 403 includes a touch panel, hardware keys such as keys and buttons, etc., for detecting user operations. In the present example, the display of information by the display unit 402 and the acceptance of user operations by the operation unit 403 are performed by the same touch panel display. Thus, the display unit 402 and the operation unit 403 are realized by a single apparatus. Button icons and a software keyboard are displayed using the display function of the display unit 402, and user contact of these items is detected by the operation acceptance function of the operation unit 403. The display unit 402 and the operation unit 403 may be separated and difference hardware elements for displaying and acceptance of operations may be provided. The power key 404 is a hardware key for accepting user operations for turning the portable terminal apparatus 104 on and off.

The portable terminal apparatus 104 includes a WLAN unit 401 that provides the WLAN communication function, where the WLAN unit 401 is not necessarily visible external to the portable terminal apparatus 104. For example, the WLAN unit 401 is configured execute data (packet) communication in a WLAN system that is compliant with the IEEE 802.11 series of standards (such as IEEE 802.11a/b/g/n/ac/ax). The WLAN unit 401 also performs communication as an AP that is compatible with Wi-Fi Agile Multiband™. This not seen to be limiting, and the WLAN unit 401 may execute communication in a WLAN system that is compliant with other standards. In the present example, the WLAN unit 401 communicates in both the 2.4 GHz and 5 GHz frequency bands. The WLAN unit 401 executes WFD-based communication, communication based on the software AP mode, communication based on the wireless infrastructure mode, etc. The operations in these modes will be described below.

### Configuration of Portable Terminal Apparatus

FIG. 4B illustrates an example configuration of the portable terminal apparatus 104. The portable terminal apparatus 104 includes, for example, a main board 411 that performs control of the portable terminal apparatus 104 and a WLAN unit 429 that performs WLAN communication. The main board 411 includes, for example, a CPU 412, a ROM 413, a RAM 414, an image memory 415, a data conversion unit 416, a telephone unit 417, a global positioning system (GPS) 419, a camera unit 421, a non-volatile memory 422, a data accumulation unit 423, a speaker unit 424, and a power supply unit 425. The portable terminal apparatus 104 includes a display unit 420 and an operation unit 418. These functional units in the main board 411 are connected to one another via a system bus 628 that is managed by the CPU 412. The main board 411 and the WLAN unit 429 are, for example, connected via a dedicated bus 426.

The CPU 412 is a system control unit that includes at least one processor, and controls the portable terminal apparatus 104. In the present example, processing by the portable terminal apparatus 104 described below is realized by the CPU 412 executing programs stored in the ROM 413. Elements of dedicated hardware for individual types of processing may be provided. The ROM 413 stores control programs, a built-in operating system (OS) program, etc., that are to be executed by the CPU 412. In the present embodiment, the CPU 412 performs software control such as scheduling and task switching by executing the control programs stored in the ROM 413 under management by the built-in OS, which is similarly stored in the ROM 413.

The RAM 414 is formed from a static RAM (SRAM) or the like. The RAM 414 stores data such as program control variables, and data such as setting values registered by the user and management data of the portable terminal apparatus 104. The RAM 414 can be used as a buffer for various types of works. The image memory 415 is formed from a memory such as a dynamic RAM (DRAM). The image memory 415 temporarily stores image data received via the WLAN unit 429 and image data read from the data accumulation unit 423 so that such image data can be processed by the CPU 412. The non-volatile memory 422 is, for example, formed from a memory such as a flash memory, and retains data stored therein even if the portable terminal apparatus 104 is turned off. The memory configuration of the portable terminal apparatus 104 is not limited to the above-described configuration. For example, the same memory shared as the image memory 415 and the RAM 414, and data backup, etc., may be performed using the data accumulation unit 423. While a DRAM is mentioned as an example of the image memory 415 in the present embodiment, a different storage medium, such as a hard disk or a non-volatile memory, may be used for the image memory 415.

The data conversion unit 416 performs analysis of data of various formats, and data conversion such as color conversion and image conversion. The telephone unit 417 realizes communication via telephone by controlling a telephone line and processing voice data input and output via the speaker unit 424. The GPS 419 receives radio waves transmitted from satellites to acquire position information such as the current latitude and longitude of the portable terminal apparatus 104.

The camera unit 421 has a function of electrically recording and encoding an image that is input via one or more lenses. Image data obtained by the camera unit 421 capturing an image is stored in the data accumulation unit 423. The speaker unit 424 performs control for realizing a function of inputting and outputting voice for the telephone function, and other functions such as alarm notification. The power supply unit 425 is, for example, a portable battery, and performs control for supplying power within the portable terminal apparatus 104. Power states include, for example, a battery-depleted state in which there is no charge remaining in the battery, a power-off state in which the power key 404 has not been selected, an operating state in which the apparatus is normally operating, and a power saving state in which the apparatus is on but operating in a power saving mode.

The display unit 420 is the display unit 402 described with reference to FIG. 4A. Based on control by the CPU 412, performs display of various input operations, the operation state and status of the MFP 100, etc. The operation unit 418 is the operation unit 403 described with reference to FIG. 4A, and, when a user operation is accepted, executes control of generating an electrical signal corresponding to the operation and outputting the electrical signal to the CPU 412, etc.

The portable terminal apparatus 104 performs data communication with other devices, such as the MFP 100, by performing wireless communication using the WLAN unit 429. The WLAN unit 429 converts data into packets and transmits the packets to other devices. The WLAN unit 429 reconstructs original data from packets from external devices and outputs the original data to the CPU 412. The WLAN unit 429 is a unit for realizing communication compliant with a WLAN standard. The WLAN unit 429 can operate concurrently in at least two communication modes including the wireless infrastructure mode and the P2P (WLAN) mode. The frequency bands used in such communication modes may be limited by hardware function and performance.

### Configuration of Access Point

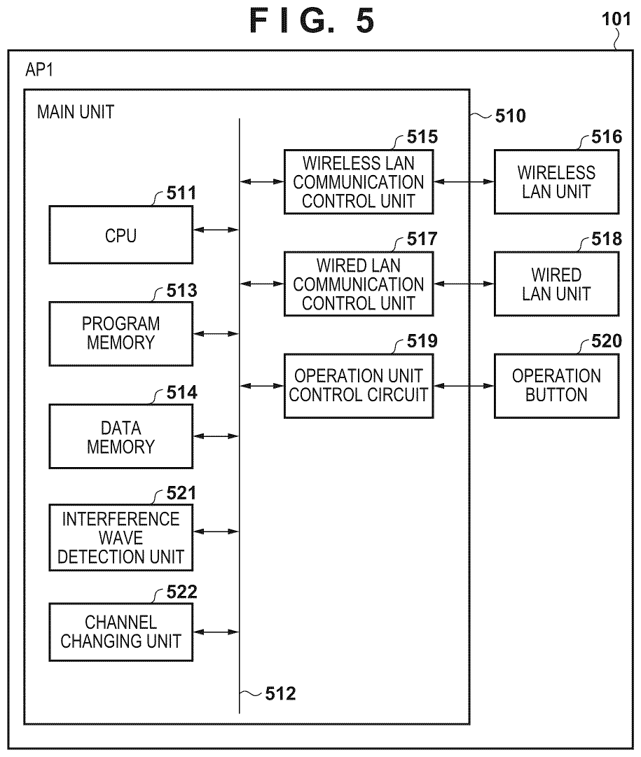

FIG. 5 is a block diagram illustrating a configuration of the AP 101 having a wireless LAN access point function. The AP 101 includes a main board 510 that controls the AP 101, a wireless LAN unit 516, a wired LAN unit 518, and an operation button 520.

A CPU 511 mounted on the main board 510 operates in accordance with a control program stored in a program memory 513 that is connected to the CPU 511 via an internal bus 512 and the contents of a data memory 514 that is connected to the CPU 511 via the internal bus 512. The CPU 511, the program memory 513, and the data memory 514 are in the form of a microprocessor, a ROM, and a RAM, respectively. The CPU 511 performs wireless LAN communication with other communication terminal apparatuses by controlling the wireless LAN unit 516 via a wireless LAN communication control unit 515. The CPU 511 performs wired LAN communication with other communication terminal apparatuses by controlling the wired LAN unit 518 via a wired LAN communication control unit 517. By controlling an operation unit control circuit 519, the CPU 511 accepts user operations performed using the operation button 520. The CPU 511 includes at least one processor.

The AP 101 includes an interference wave detection unit 521 and a channel changing unit 522. The interference wave detection unit 521 performs processing for detecting interference waves when wireless communication is being executed within a band in which Dynamic Frequency Selection (DFS) is performed. The channel changing unit 522 performs processing for changing the channel to be used in cases such as when an interference wave is detected when wireless communication is being executed in a band in which DFS is performed, or when an immediate change to a vacant channel is necessary. The AP 102 has a configuration similar to that of the AP 101.

### P2P Communication Method

Next, an overview will be provided of the P2P (WLAN) communication method, which is WLAN communication in which apparatuses perform direct wireless communication with one another without the intervention of an external access point. P2P (WLAN) communication can be realized using multiple methods, and, for example, a communication apparatus can support a plurality of modes for P2P (WLAN) communication and execute P2P communication (WLAN) by selectively using one of the plurality of modes.

The two modes below are assumed to be applicable as P2P modes:
Software AP mode
Wi-Fi Direct® (WFD) mode.

A communication apparatus that executes P2P communication can be configured to support at least one of these modes. A communication apparatus that executes P2P communication need not support all of these modes, and may be configured to support only some of the modes.

A communication apparatus having the WFD-based communication function (for example, the portable terminal apparatus 104) calls an application (may be a dedicated application in some cases) for realizing the communication function when a user operation is accepted via the operation unit of the communication apparatus. Then, the communication apparatus may display a user interface (UI) screen provided by the application to prompt user operations, and may realize WFD communication based on user operations accepted in response.
Software AP Mode

In the software AP mode, one communication apparatus (for example, the portable terminal apparatus 104) functions as a client that requests various services. The other communication apparatus (for example, the MFP 100) functions as a software AP that executes the WLAN AP function based on software settings. It is sufficient that commands and parameters defined in Wi-Fi® standards be used as the commands and parameters transmitted and received upon establishing wireless connection between a client and a software AP, thus, thereof is omitted herein. The MFP 100 operating in the software AP mode functions as the AP and determines a frequency band and a frequency channel. Thus, the MFP 100 can select which of the 5 GHz and 2.4 GHz frequency bands is to be used, and which frequency channel within the selected frequency band is to be used.
WFD Mode

The MFP 100 can be configured to always operate as a group owner (autonomous group owner) in the WFD mode. In this case, the GO Negotiation processing for determining roles is unnecessary. In addition, in this case, the MFP 100 functions as the group owner and determines a frequency band and a frequency channel. Thus, the MFP 100 can select which of the 5 GHz and 2.4 GHz frequency bands is to be used, and which frequency channel within the selected frequency band is to be used.

### Wireless Infrastructure Mode

In the wireless infrastructure mode, communication apparatuses that communicate with one another (for example, the portable terminal apparatus 104 and the MFP 100) are connected to an external AP (for example, the AP 101) that manages a network, and communication between the communication apparatuses is performed via the AP. In other words, communication between the communication apparatuses is executed via a network constructed by the external AP. The portable terminal apparatus 104 and the MFP 100 each discover the AP 101 and transmit a connection request to the AP 101 to establish connection with the AP 101, whereby these communication apparatuses can perform communication in the wireless infrastructure mode via the AP 101. The plurality of communication apparatuses may establish connection with different APs. In this case, the communication apparatuses can communicate with one another by data being transferred between the APs. It is sufficient that commands and parameters defined in Wi-Fi® standards be used as the commands and parameters transmitted and received via the access point during communication between the communication apparatuses. Thus, description thereof is omitted herein. In this case, the AP 101 determines a frequency band and a frequency channel. Thus, the AP 101 can select which of the 5 GHZ, 2.4 GHz, and 6 GHz frequency bands is to be used, and which frequency channel within the selected frequency band is to be used.

Processing in Accordance with Connection-Destination Change Request from AP to STA

The portable terminal apparatus 104 and the MFP 100 are compatible with a function that is publicly disclosed under the name of Wi-Fi Agile Multiband™. Wi-Fi Agile Multiband™ is a function that enables the optimal environment to be selected based on the changing Wi-Fi® network conditions. Specifically, an STA, such as the portable terminal apparatus 104 or the MFP 100, and an AP, such as the AP 101, exchange information relating to the network environment using the IEEE 802.11 series of communication standards. Through such exchange of information, the AP can guide the STA (change the connection destination of the STA) to a different AP, frequency band, channel, or another cellular service in some cases if the network is, for example, crowded.

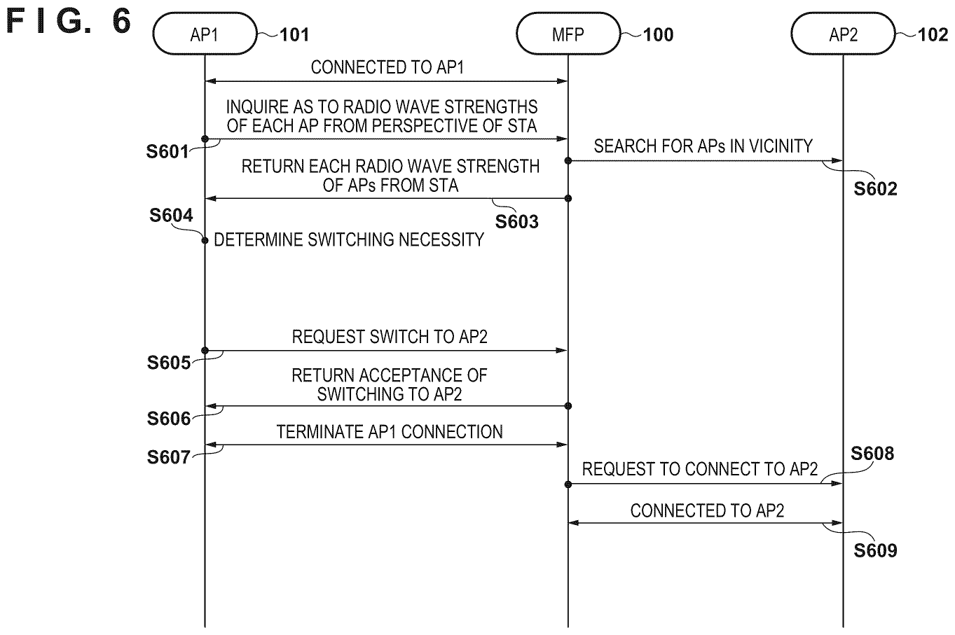

FIG. 6 is a sequence diagram illustrating a case in which the MFP 100 switches the connection-destination AP from the AP 101 to the AP 102 based on a connection destination change request from the AP 101. The processing executed by each apparatus in this sequence is realized by the each apparatus' respective CPU loading various programs stored in a memory, such as a ROM, of each respective apparatus into a RAM of each respective apparatus, and executing the loaded programs

For discussion purposes, presume that, in the initial state in the processing in FIG. 6, the MFP 100 has already established connection with the AP 101 in the wireless infrastructure mode. The following processing is executed if the AP 101, in the process in which the MFP 100 and the AP 101 establish connection in the wireless infrastructure mode, has acquired information whether the MFP 100 is compatible with IEEE 802.11v and acquired information indicating that the MFP 100 is compatible with IEEE 802.11v. The AP 101 determines whether the MFP 100 is compatible with IEEE 802.11v based on an Association Request frame that the MFP 100 transmits to the AP 101 upon establishing wireless connection therewith.

In step S601, the AP 101 transmits, to the MFP 100, an inquiry (measurement request) regarding the radio wave strengths of APs in the vicinity of the MFP 100. For example, this inquiry can be transmitted to include a beacon frame request or a beacon report request. That is, mechanisms defined by the IEEE 802.11k standard can be used for this request.

In step S602, the MFP 100, in response to the request transmitted in step S601, receives frames transmitted from APs in the vicinity to measure radio wave strengths. Thus, the radio wave strengths of a plurality of APs including the AP 101 and the AP 102 are measured.

In step S603, as a response to the request transmitted in step S601, the MFP 100 transmits a list of the radio wave strengths of the APs in the vicinity of the MFP 100 measured in step S602. Information stored in the RAM 214, the non-volatile memory 215, etc., of the MFP 100 may be adopted, in addition to or in place of the information measured in step S602, as a radio wave strength in the response. For example, this response is transmitted to include a Beacon Report or measurement reports.

In step S604, based on the state of congestion in the network acknowledged by the AP 101 and the radio wave strengths received from the MFP 100 in step S603, the AP 101 determines whether it is necessary to switch the connection destination of the MFP 100. The AP 101 determines that the connection destination needs to be switched if many STAs are connected to the AP 101 (the number of STAs connected to the AP 101 is greater than or equal to a threshold), the volume of communication between the AP 101 and the STAs connected to the AP 101 is high (the volume of communication is greater than or equal to a threshold), it is determined based on SN ratio, etc., that interfering radio waves are present/absent, the AP has stopped functioning, etc., The AP 101 may determine whether the connection destination needs to be changed based on the degree of congestion of each AP (the number of STAs connected thereto, the volume of communication) determined using inter-AP communication. Upon determining that the connection destination of the MFP 100 needs to be switched, the AP 101 advances to step S605 once the AP 101 determines a Service Set Identifier (SSID) of another AP, a channel, or a frequency band designated as the switching destination of the MFP 100. For example, the SSID of another AP designated as the connection destination after the change is the same SSID as that of the AP before the change.

In step S605, the AP 101 transmits an AP change request (connection destination switching request) to the MFP 100. The connection destination change request includes information about an SSID of another AP, a channel, or a frequency band designated as the switching destination of the MFP 100 determined in step S604. There may be cases in which a plurality of SSIDs are designated. For example, the AP 101 transmits the connection destination change request as a BTM Request. Specifically, the AP 101 transmits a BSS Transition Management (BTM) Request frame defined by the IEEE 802.11v standard. In the example in FIG. 6, the AP 102 is designated as the switching destination included in the connection destination change request.

In step S606, the MFP 100 transmits, to the AP 101, a response indicating acceptance of switching upon agreeing to follow the connection destination change request received in step S605. Upon refusing to follow the connection destination change request, the MFP 100 may transmit a refusal to switch as a response. The MFP 100 transmits the response as a BTM Response. In the example in FIG. 6, the MFP 100 transmits a response indicating acceptance of switching.

In step S607, the AP 101 and the MFP 100 terminate the connection in the wireless infrastructure mode. The MFP 100 retains the information regarding the connection to the AP 101 without deleting the information.

In step S608, to establish connection with the AP 102 designated in the connection destination change request received in step S605, the MFP 100 transmits a connection request to the AP 102. Thus, connection between the MFP 100 and the AP 102 in the wireless infrastructure mode is established in step S609. When connection between the MFP 100 and the AP 102 in the wireless infrastructure mode is established, the information regarding the connection to the AP 101 is deleted.

The above-described mechanism enables the MFP 100, which is an STA, to change the connection destination thereof from the AP 101 to the AP 102 based on the connection destination change request from the AP 101, to which the MFP 100 was originally connected. There are cases in which the AP 101 and the AP 102 are APs installed in different locations. In other words, via the processing in FIG. 6, the MFP 100 can switch to a different AP installed in a location different from that in which the AP to which the MFP 100 was originally connected is installed. There are cases in which the AP 101 and the AP 102 are APs corresponding to different frequency bands from among a plurality of frequency bands (two or three among the 2.4 GHz, 5 GHZ, and 6 GHz bands) provided by the same apparatus. In other words, via the processing in FIG. 6, the MFP 100 can switch to another frequency band provided by the same apparatus as the AP to which the MFP 100 was originally connected. For example, the MFP 100 can change the connection destination to an AP of the 6 GHz band based on the connection-destination change request.

While description is provided in the present embodiment of an example in which a measurement request and a connection destination change request from an AP are transmitted using mechanisms that are compliant with Wi-Fi Agile Multiband™, and an STA responds to the requests, this is not seen to be limiting. The present embodiment is also applicable to a configuration in which an STA responds and changes the connection destination AP (switches, deletes, or adds a connection destination AP) in response to a measurement request and a connection destination change request transmitted from an AP using mechanisms that are different from those in the above-described example.

Control in Response to Connection-Destination Change Request from AP

There are STA states in which no problem would occur even if AP switching is performed, and STA states in which a problem would occur if AP switching or disconnection from the currently connected AP is performed. A problem may occur in an STA if the STA receives an AP change request from an AP and switches the connection-destination AP based on the request during a state in which a problem would occur. For example, when an STA is prompted to switch the connection destination from a client terminal by a BTM Request from an AP while performing printing, the material being printed may be unintentionally affected (print unevenness, etc., may occur) as a result of the STA suspending the reception of print data. When an STA is prompted to switch the connection destination from a client terminal by a BTM Request from an AP while STA settings are being configured via another apparatus in the same network, the configuration of STA settings may fail based on the STA suspending the reception of data for configuring settings.

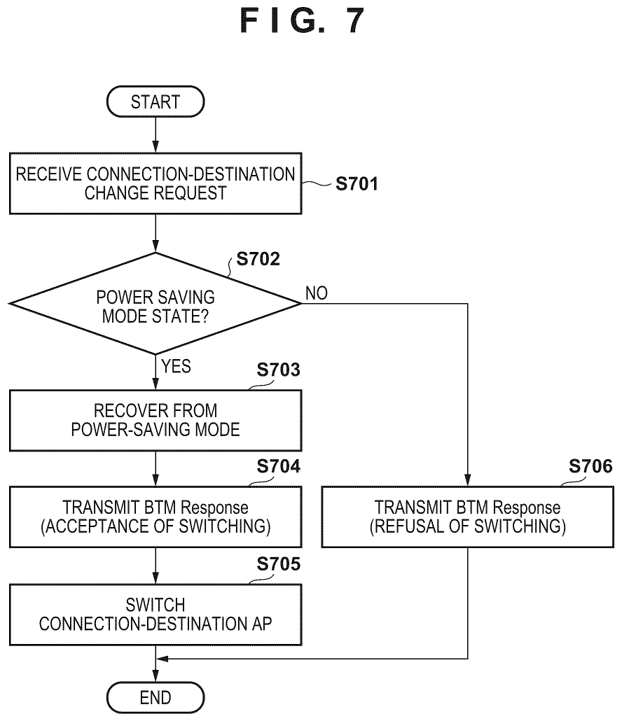

Next, control performed by the MFP 100 in response to a connection destination AP change request from the AP 101 will be described with reference to the flowchart in FIG. 7. Each step illustrated in the flowchart in FIG. 7 is realized by the CPU 212 decompressing a control program stored in a computer-readable memory, such as the ROM 213, to the RAM 214 and executing the control program in the RAM 214.

In step S701, the CPU 212 receives a connection destination AP change request from the AP 101. This corresponds to step S605 in FIG. 6.

In step S702, the CPU 212 determines whether the MFP 100 is operating in a power saving mode. The power saving mode in the present embodiment refers to a state in which the MFP 100 is operating in a state in which the operation clock frequency is lower than that during operation in a normal mode. The state in which the operation clock frequency is lower than that during operation in the normal mode is realized by reducing the operation clock frequency of the processing CPU 212 installed in the MFP 100. If a plurality of processing CPUs, such as a main CPU having a high operation clock frequency and a sub CPU having a low operation clock frequency, are installed in the MFP 100, the state in which the operation clock frequency is lower than that during operation in the normal mode may be realized by switching the processing CPU to the sub CPU having a low operation clock frequency.

The power saving mode in the present embodiment refers to a state in which power is supplied to a smaller number of blocks than during operation in the normal mode. For example, if power is supplied to all blocks in the MFP 100 during operation in the normal mode, the power saving mode refers to a state in which the supply of power to the read control unit 217, the reading unit 219, the printing unit 222, and the print control unit 224 is stopped.

The flow advances to step S703 if it is determined in step S702 that the MFP 100 is operating in the power saving mode. If the MFP 100 is in a power saving mode (second power saving mode) in which power consumption is even lower than in the above-described power saving mode (first power saving mode), such as that in which the supply of power to even the wireless unit 226 in the MFP 100 is stopped, the connection destination change request is not received. The MFP 100 cannot receive the connection destination change request when in the second power saving mode because, when in the second power saving mode, operation is limited to a further extent compared to in the normal power saving mode such that the MFP 100 cannot communicate with other apparatuses. Thus, if the MFP 100 is in the second power saving mode, the processing in FIG. 7 is not executed, and the connection destination AP is not changed.

In step S703, the CPU 212 causes the MFP 100 to recover from the power saving mode. The recovery from the power saving mode is realized by changing the operation clock frequency of the processing CPU to that during operation in the normal mode or switching the processing CPU to the main CPU used during operation in the normal mode. Via the processing in step S703, the MFP 100 can be placed in a state in which the connection destination AP can be switched. The flow may advance to step S704 without recovery from the power saving mode if the connection destination AP can be switched while the power saving mode is maintained. A configuration may be adopted such that the MFP 100 does not recover from the power saving mode at the timing when the connection destination change request is received, and the processing in and following step S704 progresses once the MFP 100 recovers from the power saving mode by separately accepting a user operation or the like.

In step S704, the CPU 212 transmits, to the AP 101, a response indicating acceptance of switching. For example, the response indicating acceptance of switching is a BTM Response. In step S705, the CPU 212 switches the connection-destination AP to the AP 102. Then, the processing in FIG. 7 ends.

After step S705 is executed, the CPU 212 causes the MFP 100 to transition to the power saving mode. The switch to the power saving mode is realized by changing the operation clock frequency of the processing CPU to that during operation in the power saving mode or switching the processing CPU to the sub CPU used during operation in the power saving mode. Thus, the connection destination AP is changed, and the MFP 100 can also be returned to the power saving state. The flow advances to step S706 if it is determined in step S702 that the MFP 100 is not operating in the power saving mode. In step S706, the CPU 212 transmits, to the AP 101, a response indicating refusal to switch the connection destination AP, and maintains the connection with the AP 101. Following step S706, the processing in FIG. 7 ends. If a response indicating refusal to switch the connection destination AP is transmitted, the priority of changing the connection destination of other STAs that are connected to the AP currently connected to the MFP 100 increases, and the priority of changing the connection destination AP of the MFP 100, which has returned the response of refusal, is reduced. Thus, the possibility that the connection with the AP to which the MFP 100 is currently connected can be maintained consequently increases.

Based on the above processing, in the present embodiment, upon receiving a connection destination AP change request from the AP 101, the MFP 100 operates to respond with an acceptance to switch the connection destination AP when in the power saving mode and respond with a refusal to switch the connection destination AP when not in the power saving mode.

Thus, no problem will occur even if the connection destination AP is switched because there is no possibility of the user performing printing using the MFP 100 or configuring the settings thereof when the MFP 100 is in the power saving state. Because the MFP 100 operates to respond with an acceptance to switch the connection destination AP only when in the power saving mode in the present embodiment, the connection destination AP can be switched while avoiding a state in which a problem occurs due to the switching of the connection destination AP.

In the present embodiment, description has been provided that a response indicating refusal to switch is transmitted to the AP 101 as a BTM Response (step S706). A different type of processing may be performed as processing for preventing the connection destination from being changed.

For example, a configuration may be adopted such that, even if the change request described in step S605 is received, a response to the change request is not returned (the change request is ignored) so that changing of the connection destination AP based on the received change request is not performed. If no response is returned, the currently connected AP, in order to wait for a response, maintains the connection with the MFP 100 until a response waiting time results in a time out. Accordingly, even if the currently connected AP is configured to terminate connection immediately once a response to the change request is received from the MFP 100, the connection with the currently connected AP can be maintained by not responding rather than returning a response.

A configuration may, for example, be adopted such that the determination processing in step S702 in FIG. 7 is performed before a connection destination AP change request from the AP 101 is received. In this case, if it is determined in step S702 that the MFP 100 is not operating in the power saving mode, in step S706, in response to a measurement request from the currently connected AP, information indicating a radio wave condition (low signal quality) that is different from the actually measured condition is transmitted in regard to the radio-wave reception condition (signal reception condition) from non-connected APs that are APs other than the currently connected AP (i.e., a false response is returned). In this case, the response may be returned after actually performing measurement in response to receipt of the measurement request or may be returned without actually performing measurement. Specifically, in the response (Beacon Report or the like) described with regard to step S603, a value obtained by reducing the received signal strength and/or a value obtained by increasing noise (noise-to-signal ratio) relative to the measured signal quality is returned as signals received from the non-connected APs. Alternatively, a response in which information regarding at least one non-connected AP is not included may be returned. Alternatively, based on previously measured information for the non-connected APs, processing of returning significantly low received signal strength values or processing of responding with values in which noise is significantly increased may be performed. Alternatively, a configuration may be adopted such that, even if a measurement request is received, actual measurement (AP search) is not performed, and a response is returned indicating excellent received signal strength and noise condition only for the currently connected AP without including information about the non-connected APs. A response to a measurement request in which information regarding non-connected APs is not included is equivalent to indicating that no other APs (non-connected APs) were found even though an AP search was performed. By adopting such a configuration, connection destination change requests to other APs can be prevented from being transmitted from the currently connected AP. Accordingly, changing of the connection destination based on a connection destination AP change request can be prevented from being performed.

Upon adopting a configuration such that the determination processing in step S702 in FIG. 7 is performed before receiving a connection destination AP change request from the AP 101, a configuration may be adopted such that the connection with the currently connected AP is temporarily terminated, the currently connected AP is notified of information indicating incompatibility with the change request, and connection with the same AP is re-established. Specifically, the wireless connection with the currently connected AP is temporarily terminated, and, in preparation for re-establishing wireless connection, Association Request frame data including information indicating incompatibility with IEEE 802.11v is created. Then, processing for establishing connection with the AP is performed using the created Association Request frame data. This results in the MFP 100 being connected with the AP as an electronic apparatus that is not compatible (incompatible) with the Agile Multiband function if an Association Request frame including information indicating incompatibility with IEEE 802.11v is created. Due to this, the currently connected AP ceases to transmit connection-destination-AP change requests to the MFP 100, acknowledging that the MFP 100 is incompatible with IEEE 802.11v. Thus, because the MFP 100 ceases to be requested to change the connection-destination AP, the wireless connection between the MFP 100 and the currently connected AP is more likely to be maintained. If the currently connected AP acknowledges that the MFP 100 is incompatible with IEEE 802.11v, the transmission of measurement requests (request described in step S601) from the currently connected AP to the MFP 100 will also be suppressed. Accordingly, measuring performed based on measurement requests (AP search) and returning of responses to measurement requests (processing in step S603) can also be suppressed from being performed by the MFP 100. Processing load and power consumption can be reduced accordingly, and resources can be allocated to other processing.

### Second Embodiment

A second embodiment will now be described focusing on differences from the first embodiment. There are cases in which failure to respond to an AP change request results in disconnection from the currently connected AP. For example, if the reason of request included in a connection destination AP change request indicates that connection with the AP will be terminated, STA AP connection will be terminated unless the STA responds to the AP change request. In view of this, in the present embodiment, even if the MFP 100 is not in the power saving state, the connection destination AP is switched if the reason of request included in a connection destination AP change request is a predetermined reason, e.g., a reason corresponding to termination of the connection with the AP 101.

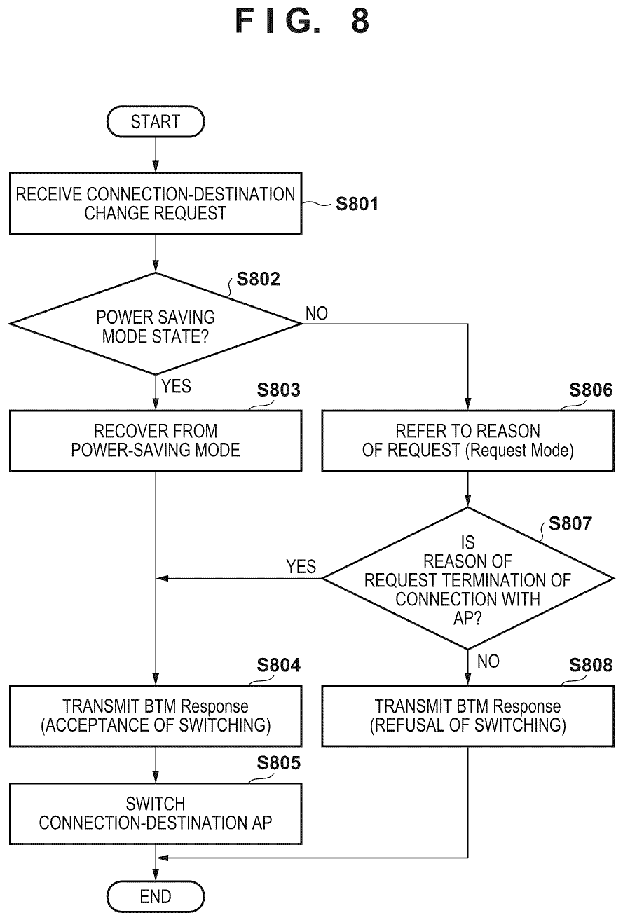

Control performed by the MFP 100 in response to a connection destination AP change request from the AP 101 in the present embodiment will be described with reference to the flowchart in FIG. 8. Each step illustrated in the flowchart in FIG. 8 is realized by the CPU 212 decompressing a control program stored in a computer-readable memory, such as the ROM 213, to the RAM 214 and executing the control program in the RAM 214. Description regarding steps S801 to S805 is omitted because these steps are the same as steps S701 to S705 in FIG. 7.

The flow proceeds to step S806 if it is determined in step S802 that the MFP 100 is not operating in the power saving mode. In step S806, the CPU 212 refers to the reason of request (Request Mode) included in the connection destination AP change request from the AP 101. For example, the CPU 212 refers to the reason of request using the following bits included in the change request:
Preferred Candidate List Included bit indicating whether a transition candidate list is included in the BTM Request frame
Abridged Bit indicating whether APs recommended by the STA are present in the transition candidate list
Disassociation Imminent Bit indicating whether the connection with the current AP will be terminated
BSS Termination Included Bit indicating whether Basic Service Set (BSS) is shutting down and the connection with the AP will be terminated
ESS Disassociation Imminent Bit indicating that a Session Information URL field is included in the BTM Request frame and the STA will be disassociated from ESS.

In step S807, the CPU 212 determines whether termination of the connection with the AP 101 is indicated as the reason of request. For example, the CPU 212 determines whether the termination of the connection with the AP 101 is indicated if the Disassociation Imminent Bit, which indicates whether the connection with the current AP will be terminated, or the BSS Termination Included Bit, which indicates whether BSS is shutting down and the connection with the AP will be terminated, is set. Upon determining that it is indicated that the connection between the AP 101 and the MFP 100 will be terminated, the flow proceeds to step S804 and the CPU 212 transmits, to the AP 101, an acceptance of switching. Then, in step S805, the CPU 212 switches the connection destination AP to the AP 102. The flow proceeds to step S808 if it is determined in step S807 that it is not indicated that the connection with the AP 101 will be terminated.

In step S808, the CPU 212 transmits, to the AP 101, a response indicating refusal to switch the connection destination AP, and maintains the connection with the AP 101. Following step S808, the processing in FIG. 8 ends. A configuration may be adopted such that a response to the change request is not returned (the change request is ignored) in step S808.

According to the present embodiment, even if the MFP 100 is not in the power saving state, the connection destination AP is switched if the reason of request included in a connection destination-AP change request is a predetermined reason, e.g., a reason corresponding to termination of the connection with the AP 101.

Upon receiving, from the AP 101, a connection destination AP change request to the AP 102, the MFP 100 responds to the AP change request even if the MFP 100 is not in the power saving mode if the reason of request included in the connection destination AP change request indicates that the connection with the AP will be terminated. Thus, a situation can be prevented in which AP connection is terminated due to failure in responding to the AP change request.

The control discussed in the above-described embodiments as being performed by the MFP 100 may be performed by a single hardware element. Control of the above-described apparatuses may be performed by processing distributed among a plurality of hardware elements, e.g., a plurality of processors and circuits.

While the present disclosure has been described in detail based on the above-described embodiments, the present disclosure is not limited to these specific embodiments, and may encompass various forms that implement the features discussed above. The above-described embodiments each merely indicate one embodiment of the present disclosure, and the embodiments may be combined as appropriate.

The above-described embodiments discuss, as an example, a case in which the present disclosure is applied to the MFP 100.; This is not seen to be limiting, and are applicable to any wireless apparatus that has a plurality of operation modes and functions as an STA that can perform processing based on a connection destination change request from an AP. Specifically, the present disclosure is applicable to personal computers, PDAs, tablet terminals, mobile phone terminals such as smartphones, music players, game machines, electronic book readers, smartwatches, and various measurement apparatuses (sensor apparatuses) such as thermometers and hygrometers. The present disclosure is also applicable to digital cameras (including still cameras, video cameras, network cameras, and security cameras), printers, scanners, and drones. The present disclosure is applicable to video output apparatuses, audio output apparatuses (smart speakers, for example), media streaming players, and wireless LAN client devices (adapters) to which USB terminals and LAN cable terminals can be connected. Video output apparatuses include, for example, apparatuses that acquire (download) an Internet video identified by a URL designated from an electronic apparatus and output the acquired video to a display apparatus that is connected via a video output terminal compliant to HDMI® or the like, and thereby realize streaming playback on the display apparatus or mirroring display on the display apparatus (displaying the content displayed on the electronic apparatus also on the display apparatus). Video output apparatuses also include television sets, media players such as hard disk recorders, Blu-ray recorders, and DVD recorders, head-mounted displays, projectors, television sets, display apparatuses (monitors), signage apparatuses, and the like. The present disclosure also applies to Wi-Fi® compatible devices smart devices, such as air conditioners, refrigerators, washing machines, vacuum cleaners, ovens, microwave ovens, lighting fixtures, heating appliances, and cooling appliances.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-017433, filed Feb. 7, 2024, which is hereby incorporated by reference herein in its entirety.

What is claimed is:

1. An electronic apparatus comprising:
a communication device configured to receive, from a currently connected access point, a change request to change an access point that is a connection destination; and
at least one memory storing a program and at least one processor that when executing the program is configured to:
perform control so that processing for changing the connection destination based on the change request is not performed if the electronic apparatus is in, from among a first mode and a second mode, the first mode, wherein a clock frequency of the at least one processor is lower in the second mode than in the first mode, and
perform control so that processing for changing the connection destination based on the change request is performed if the electronic apparatus is in the second mode.

2. The electronic apparatus according to claim 1, wherein the at least one processor is further configured to perform control so that processing for changing the connection destination based on the change request is not performed if the electronic apparatus is in, from among the first mode, the second mode, and a third mode, the third mode, wherein the clock frequency of the at least one processor is lower in the third mode than in the second mode.

3. The electronic apparatus according to claim 2,
wherein the second mode is a power saving mode in which power consumption is less than in the first mode, and wherein the third mode is a power saving mode in which power consumption is less than in the second mode.

4. The electronic apparatus according to claim 2,
wherein the third mode is a mode in which power is not supplied to a communication interface that is used by the electronic apparatus to communicate external to the electronic apparatus.

5. The electronic apparatus according to claim 1, wherein the at least one processor is further configured to perform control so that the processing for changing the connection destination based on the change request is not performed even if the change request is received when the electronic apparatus is in the first mode, and to perform control so that the processing for changing the connection destination based on the change request is performed if the change request is received when the electronic apparatus is in the second mode.

6. The electronic apparatus according to claim 1, wherein the at least one processor is further configured to perform control so that, even if the electronic apparatus is in the first mode, the processing for changing the connection destination based on the change request is performed if information included in the change request indicating a reason to change the connection destination indicates a predetermined reason.

7. The electronic apparatus according to claim 6, wherein the at least one processor is further configured to perform control so that the processing for changing the connection destination based on the change request is not performed if the information indicating the reason to change the connection destination does not indicate the predetermined reason.

8. The electronic apparatus according to claim 6, wherein the predetermined reason is a reason corresponding to termination of connection between the currently connected access point and the electronic apparatus.

9. The electronic apparatus according to claim 6, wherein the predetermined reason is represented by a bit included in the change request.

10. The electronic apparatus according to claim 9, wherein the bit included in the change request comprises at least a Disassociation Imminent Bit or a BSS Termination Included Bit.

11. The electronic apparatus according to claim 1, wherein, if the electronic apparatus is in the first mode, the at least one processor performing control so that the processing for changing the connection destination based on the change request is not performed includes transmitting a response indicating refusal to switch the connection destination to the connection destination.

12. The electronic apparatus according to claim 1, wherein, if the electronic apparatus is in the second mode, the least one processor performing control so that the processing for changing the connection destination based on the change request is performed includes transmitting a response indicating acceptance of switching of the connection destination to the connection destination.

13. The electronic apparatus according to claim 1 further comprising a printer that prints an image on a printing medium.

14. The electronic apparatus according to claim 1, wherein the electronic apparatus can implement an operation compatible with at least orthogonal frequency division multiple access (OFDMA) or Target Wake Time (TWT).

15. The electronic apparatus according to claim 1, wherein the electronic apparatus can implement an operation compliant with IEEE 802.11ax.

16. The electronic apparatus according to claim 1, wherein the at least one processor performing control to change the connection destination based on the change request includes performing control to change the connection destination to a 6 GHz frequency band access point.

17. A method executed by an electronic apparatus, the method comprising:
receiving, from a currently connected access point, a change request to change an access point that is a connection destination;
performing control so that processing for changing the connection destination based on the change request is not performed if the electronic apparatus is in, from among a first mode and a second mode, the first mode, wherein a clock frequency of the at least one processor is lower in the second mode than in the first mode; and
performing control so that the processing for changing the connection destination based on the change request is performed if the electronic apparatus is in the second mode.

18. A non-transitory computer-readable storage medium storing one or more programs that when executed by at least one processor of an electronic apparatus causes the electronic apparatus to execute a method, the method comprising:
receiving, from a currently connected access point, a change request to change an access point that is a connection destination;
performing control so that processing for changing the connection destination based on the change request is not performed if the electronic apparatus is in, from among a first mode and a second mode, the first mode wherein a clock frequency of the at least one processor is lower in the second mode than in the first mode; and
performing control so that the processing for changing the connection destination based on the change request is performed if the electronic apparatus is in the second mode.
